(19) United States
(12) Patent Application Publication
(10) Pub. No.: US 2010/0241663 A1
(43) Pub. Date: Sep. 23, 2010

(54) PROVIDING CONTENT ITEMS SELECTED BASED ON CONTEXT

(75) Inventors: Xuedong Huang, Bellevue, WA (US); Shipeng Li, Palo Alto, CA (US); Zheng Chen, Beijing (CN)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/791,091

(22) Filed: Jun. 1, 2010

Related U.S. Application Data
(63) Continuation-in-part of application No. 12/027,516, filed on Feb. 7, 2008.

(51) Int. Cl. G06F 17/30; G06F 12/08

(52) U.S. Cl. 707/770; 711/118; 707/776; 707/E17.014; 711/E12.017

(57) ABSTRACT

Systems, methods, and computer storage media having computer-executable instructions embodied thereon that provide content items selected based on context are provided. Contextual indicators associated with a user are identified and utilized to determine one or more content items that the user is likely to desire to access at a particular point in time. Upon receiving an indication that the user desires to perform a context-aware search, the identified content items (or references thereto) are presented automatically to the user, that is, without the user having to input any search query terms. The indication that the user desires to perform a context-aware search may be received, for instance, upon receiving an indication that a selectable context-aware search button has been selected by the user. This single-button action is particularly useful for mobile computing devices, wherein alpha-numeric textual input is relatively difficult.

### CROSS-REFERENCE TO RELATED APPLICATIONS

The present application is continuation-in-part of pending U.S. application Ser. No. 12/027,516, filed Feb. 7, 2008 and entitled “Providing Relevant Advertisements or Other Content Based on a Communications Identifier,” the disclosure of which is hereby incorporated by reference as if set forth in its entirety herein.

### BACKGROUND

Many computing device users are habitual, or at least engage in some reasonably predictable behaviors on a routine basis. For instance, a particular user may routinely conduct a search for “world news” first thing in the morning to view headlines from prominent overnight news stories. Or, a user may routinely search for online television listings in the early evening to determine if there is any program they are interested in watching. Or, a user may routinely search for an online traffic report before leaving their office for the afternoon. Additionally, computing device users often engage in search behaviors that are relevant to events or activities that have taken place or are going to take place within close proximity to the time of the search behavior. For instance, if a user has dinner plans at a new restaurant in town at 6:30 pm, a few hours prior to that time, he or she may conduct a search for directions to the restaurant and/or peruse the menu or specials offerings online. Or, a user may have been engaged in an email conversation with a friend early in the day and, a few hours later, conduct a search for information about a book the friend recommended during the conversation.

While each of these scenarios is somewhat predictable, at least with a degree of confidence greater than that of purely random search behavior, they still require that the user access an online search application and input one or more search query terms to access the information (and/or links to the information) he or she desires to access. At times, e.g., when the user is stressed for time, such query-inputting can be problematic. This is particularly true when the user is engaged in search behavior on a mobile computing device where alpha-numeric textual input is relatively difficult.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable media for, among other things providing content items selected based on context. Various “contextual indicators” associated with a user, for instance, routine search behaviors, recent text and/or email conversations engaged in by the user, events scheduled on the user's electronic calendar, multimedia events engaged in by the user (such as listening to music, watching television programming, etc.) and the like, are identified. The contextual indicators are then used to identify content items that the user has an increased likelihood (relative to information unrelated to the current context surrounding the user) of desiring to access. Upon receiving an indication that the user desires to perform a context-aware search, for instance, upon receiving an indication that a context-aware search button has been selected, the identified content items (and/or a link thereto) are presented automatically to the user, without the user having to input any search query terms. Also presented is a search query input region configured for receiving user-input search query terms. As such, if the presented information (and/or information links) does not align with what the user wanted to have presented upon selecting the context-aware search button, he or she may input search query terms and a search will be conducted for information related to the input terms in a conventional manner, though with an enhanced assessment of the intent of the user which may prove beneficial in determining search results.

### BRIEF DESCRIPTION OF THE DRAWINGS

The present invention is illustrated by way of example and not limited in the accompanying figures in which like reference numerals indicate similar elements and in which:

FIG. 1 is a block diagram of an exemplary computing system environment suitable for use in implementing embodiments of the present invention;

FIG. 2 is a schematic diagram of an exemplary mobile computing device including a user interface on which content items selected based on context may be presented, the device being suitable for use in implementing embodiments of the present invention;

FIG. 3 is a flow diagram showing a method for providing content items selected based on context, in accordance with embodiments of the present invention;

FIG. 4 is a flow diagram showing another method for providing content items selected based on context, in accordance with embodiments of the present invention;

FIG. 5 is a block diagram of an exemplary mobile telephone including a user interface on which content items selected based on context may be made visible to a user, in accordance with an embodiment of the present invention; and

FIG. 6 is a block diagram showing an exemplary computing system environment suitable for implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable media for, among other things, providing content items selected based on context of a user. Contextual indicators associated with a user are identified and utilized to predict one or more content items that the user is likely to desire to access at a particular point in time, e.g., the point in time at which the content items are determined. Contextual indicators are indicators of habitual or routine behaviors of the user and/or indicators associated with events, activities or behaviors of the user and may include, by way of example only, routine search behaviors, recent text and/or email conversations engaged in by the user, events scheduled on the user's electronic calendar, multimedia events engaged in by the user (such as listening to music, watching television programming, etc.), and the like. For instance, a user may routinely search for traffic reports around 7:00 a.m. Thus, content items determined during the early morning hours may include traffic information (and/or links thereto). Or, a user's electronic calendar may indicate they have a lunch appointment across town. In this instance, content items determined during the two hours prior to the lunch appointment may include directions to the restaurant and/or a link to the restaurant's lunch specials for the day. The identified content items are content items that, based on the context surrounding the user either routinely/habitually or specific to a particular point in time, the user has an increased likelihood (relative to information unrelated to the current context surrounding the user) of desiring to access.

Upon receiving an indication that the user desires to perform a context-aware search, the identified content items (or links thereto) are presented automatically to the user, that is, without the user having to input any search query terms. The indication that the user desires to perform a context-aware search may be received, for instance, upon receiving an indication that a selectable context-aware search button has been selected by the user. As the identified content items are presented without user input of any search query terms, the content items are quickly and efficiently presented to the user, with minimal user effort. In fact, the user may need only press a single button to have the information he or she desires readily at his/her fingertips. This single-button action is particularly useful for mobile computing devices, wherein alpha-numeric textual input is relatively difficult.

Also presented is a search query input region configured for receiving user-input search query terms. As such, if the presented information (and/or information links) does not align with what the user wanted to have presented upon selecting the context-aware search button, he or she may input search query terms and a search will be conducted for information related to the input terms in a conventional manner, though with an enhanced assessment of the intent of the user which may prove beneficial in determining search results.

Accordingly, in one aspect, the present invention is directed to one or more computer storage media having computer-executable instructions embodied thereon, that when executed, causes a computing device to perform a method for providing content items selected based on context. The method includes receiving at least one contextual indicator associated with a user, using the at least one contextual indicator to select at least one content item, receiving an indication that a context-aware search has been requested, and automatically providing the at least one content item for output in association with the computing device in response to the context-aware search request and in the absence of receiving any user-input search query terms. The at least one content item is one of visible information, audible information and a combination of visible and audible information.

In another aspect, the present invention is directed to a content delivery system comprising a computing device associated with one or more processors and one or more computer storage media, a data store coupled with the computing device, and a content item selection engine. The content item selection engine receives at least one contextual indicator associated with a user of the computing device, selects at least one content item based upon the at least one contextual indicator, and automatically provides the at least one content item for output in association with the computing device in response to receiving an indication that a context-aware search has been requested and in the absence of receiving any user-input search query terms.

In yet another aspect, the present invention is directed to one or more computer storage media having computer-executable instructions embodied thereon, that when executed, causes a computing device to perform a method for providing content items selected based on context. The method includes receiving a plurality of contextual indicators associated with a user; determining a plurality of content items capable of being presented in association with a user interface on the computing device; associating a likelihood with each of the plurality of content items indicative of how likely it is that the user wishes presentation of the associated content item; receiving an indication that a context-aware search selector has been selected; automatically presenting a portion of the plurality of content items in association with a first region of the user interface in response to the selection of the context-aware search selector and in the absence of receiving any user-input search query terms, wherein content items comprising the portion of the plurality of content items are selected for presentation based upon relative associated likelihoods; and presenting a search query input region configured for receiving at least one user-input search query term in association with a second region of the user interface in response to the selection of the context-aware search selector.

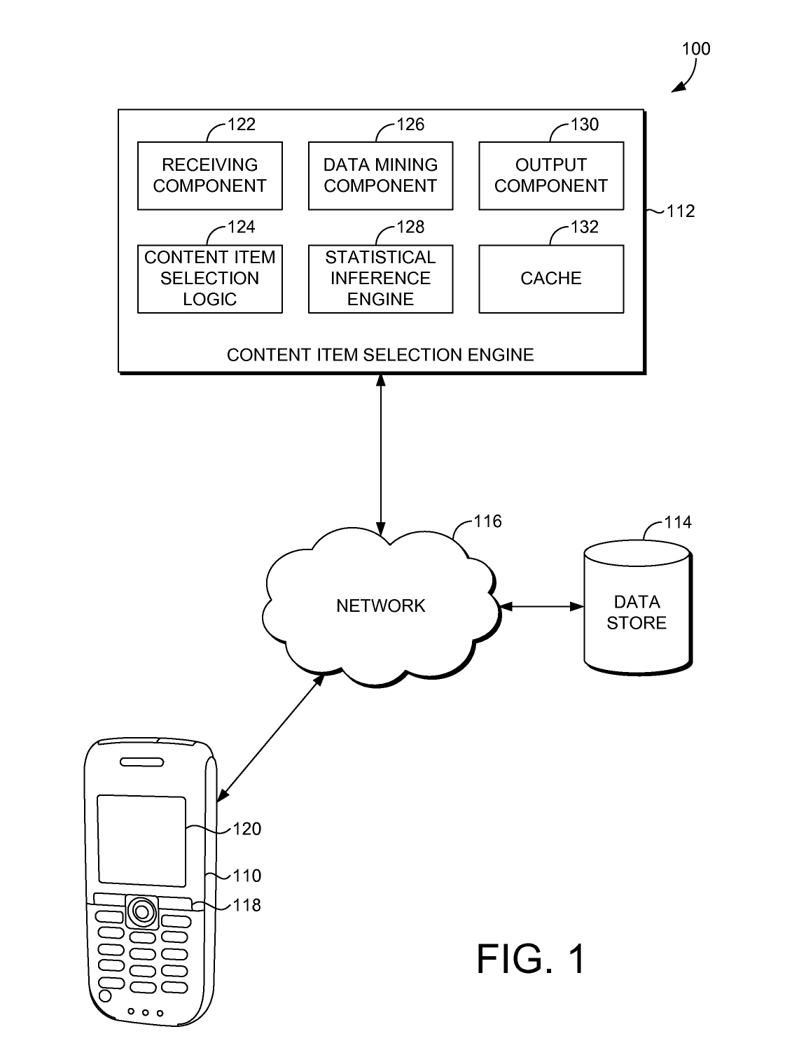

Turning now to FIG. 1, a block diagram is illustrated that shows an exemplary computing system environment 100 suitable for use in implementing embodiments of the present invention. It will be understood and appreciated by those of ordinary skill in the art that the computing system environment 100 shown in FIG. 1 is merely an example of one suitable computing system environment and is not intended to suggest any limitation as to the scope of use or functionality of embodiments of the present invention. Neither should the computing system environment 100 be interpreted as having any dependency or requirement related to any single module/component or combination of modules/components illustrated therein.

The computing system environment 100 includes a computing device 110 (illustrated in FIG. 1 as a mobile computing device), a content item selection engine 112 and a data store 114, all in communication with one another via a network 116. The network 116 may include, without limitation, one or more local area networks (LANs) and/or wide area networks (WANs). Such networking environments are commonplace in offices, enterprise-wide computer networks, intranets and the Internet. Accordingly, the network 116 is not further described herein.

In some embodiments, one or more of the illustrated components/modules may be implemented as stand-alone applications. In other embodiments, one or more of the illustrated components/modules may be integrated directly into the operating system of the content item selection engine 112 and/or the end-user computing device 110. It will be understood by those of ordinary skill in the art that the components/modules illustrated in FIG. 1 are exemplary in nature and in number and should not be construed as limiting. Any number of components/modules may be employed to achieve the desired functionality within the scope of embodiments hereof. Further, components/modules may be located on any number of servers or client computing devices. By way of example only, the content item selection engine 112 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 114 is configured to store information associated with contextual indicators and content items. In various embodiments, such information may include, without limitation, profile data, computing device state data, routine search behaviors, recent text and/or email conversations engaged in by the user, events scheduled on the user's electronic calendar, multimedia events engaged in by the user (such as listening to music, watching television programming, etc.), links to uniform resource locators (URLs) frequented by the user, links to URLs having information associated with events scheduled on the user's electronic calendar and/or with keywords extracted from text and/or email conversations engaged in by the user, and/or the like. In embodiments, the data store 114 is configured to be searchable for one or more of the items stored in association therewith. It will be understood and appreciated by those of ordinary skill in the art that the information stored in association with the data store 114 may be configurable and may include any information relevant to one or more contextual indicators, content items, and/or the like. The content and volume of such information are not intended to limit the scope of embodiments of the present invention in any way. Further, though illustrated as a single, independent component, the data store 114 may, in fact, be a plurality of storage devices, for instance a database cluster, portions of which may reside on the content item selection engine 112, the computing device 110, another external computing device (not shown), and/or any combination thereof.

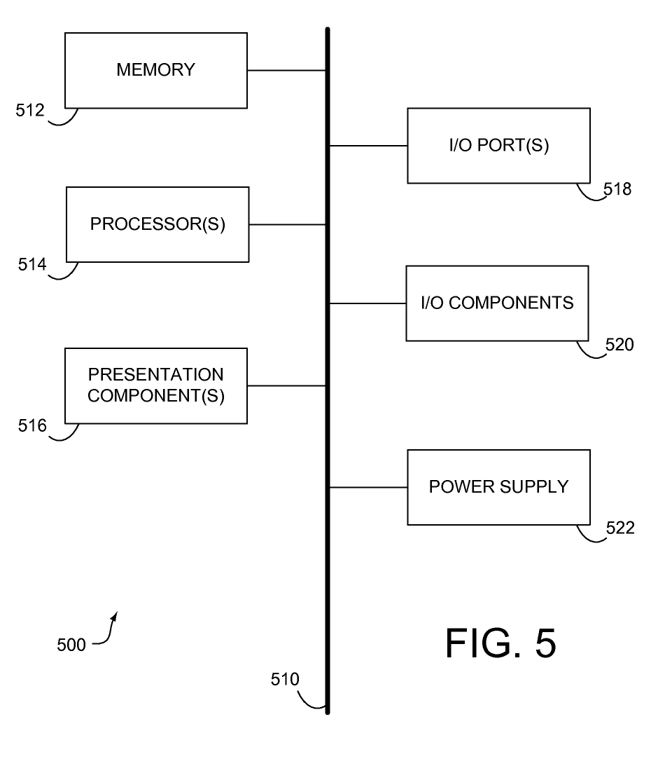

Each of the computing device 110 and the content item selection engine 112 shown in FIG. 1 may be any type of computing device, such as, for example, computing device 500 described below with reference to FIG. 5. By way of example only and not limitation, each of the computing device 110 and the content item selection engine 112 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

Components of the computing device 110 and the content item selection engine 112 (not shown for clarity) may include, without limitation, a processing unit, internal system memory, and a suitable system bus for coupling various system components, including one or more databases for storing information (e.g., files and metadata associated therewith). Each of the computing device 110 and the content item selection engine 112 typically includes, or has access to, a variety of computer-readable media. By way of example, and not limitation, computer-readable media may include computer-storage media and communication media. In general, communication media enables each server to exchange data via a network, e.g., network 116. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system environment 100 is merely exemplary. While the content item selection engine 112 is illustrated as a single unit, one skilled in the art will appreciate that the content item selection engine 112 is scalable. For example, the content item selection engine 112 may in actuality include a plurality of computing devices in communication with one another. Moreover, the data store 114, or portions thereof, may be included within the content item selection engine 112 and/or the computing device 112 as a computer-storage medium. The single unit depictions are meant for clarity, not to limit the scope of embodiments in any form.

The computing device 110 shown in FIG. 1 is a mobile computing device, such as a mobile telephone. It will be understood by those of ordinary skill in the art that the mobile computing device 110 is merely exemplary and that the computing device 110 may be any type of computing and/or communication device, such as a personal computer, textual communication device, or the like. The computing device 110 includes a context-aware search selector 118 and a display screen 120. The context-aware search selector 118 shown in FIG. 1 is a single hardware button that, when selected, triggers an indication to the content item selection engine 112 that a context-aware search is desired. While shown in FIG. 1 as a hardware search selector, the context-aware search selector 118 may be a software search selector, a hardware search selector, or a combination hardware and software search selector, as desired.

The display screen 120 is configured to display information to the user of the computing device 110, for instance, information relevant to communications initiated by and/or received by the computing device 110, browsing activity, content items, and the like. Embodiments are not intended to be limited to visual display but rather may also include audio presentation, combined audio/visual presentation, and the like.

As shown in FIG. 1, the content item selection engine 112 includes a receiving component 122, content item selection logic 124, a data mining component 126, a statistical inference engine 128, an output component 130 and a cache 132. In some embodiments, one or more of the components 122, 124, 126, 128, 130 and 132 may be implemented as stand-alone applications. In other embodiments, one or more of the components 122, 124, 126, 128, 130 and 132 may be integrated directly into the operating system of the computing device 110. It will be understood by those of ordinary skill in the art that the components 122, 124, 126, 128, 130 and 132 illustrated in FIG. 1 are exemplary in nature and in number and should not be construed as limiting. Any number of components may be employed to achieve the desired functionality within the scope of embodiments hereof.

The receiving component 122 is configured for receiving contextual indicators associated with a user. Contextual indicators are indicators of habitual or routine behaviors of the user and/or indicators associated with events, activities or behaviors of the user. Contextual indicators may include, by way of example only, routine search behaviors of the user, recent text and/or email conversations engaged in by the user, events scheduled on the user's electronic calendar, multimedia events engaged in by the user (such as listening to music, watching television programming, etc.), and the like. For instance, if a user routinely searches for traffic reports around 7:00 am, a contextual indicator of this behavior may be received. In embodiments, the receiving component 122 is configured for receiving a plurality of contextual indicators associated with a user. Thus, if a user's electronic calendar indicates s/he is to meet a friend for dinner at 7:00 pm at a particular restaurant, a contextual indicator of the friend's identity, the current location of the user, and/or the identity of the restaurant may be received. Further, if the same user routinely checks traffic conditions upon leaving the office around 6:00 pm, a contextual indicator of this behavior may be received in addition to the contextual indicator(s) associated with the user's dinner appointment. The receiving component 122 is further configured for receiving profile data associated with the user. In embodiments, such information may be input and/or changed directly by the user.

Still further, the receiving component 122 is configured for receiving an indication that a context-aware search has been requested. In embodiments, such indication is received upon a user pressing a single context-aware search selector, for instance, the context-aware search selector 118 of the computing device 110. Upon receipt of the indication that a context-aware search has been requested, the at least one content item is automatically provided for output in association with the computing device 110, as more fully described below.

The content item selection logic 124 is configured for selecting at least one content item using the at least one contextual indicator received by the receiving component 122. That is, the content item selection logic 124 comprises one or more rules that utilize the one or more contextual indicators received by the receiving component 122 to determine content items that the user has an increased likelihood of desiring to have presented. Such content item selection logic 124 may include utilization of profile data associated with the user, data associated with the current state of the computing device 110 (which may include a current time and/or location of the computing device), or a combination of profile data and current state data to select the at least one content item. In embodiments, profile data may be provided directly by the user and may include information such as age, sex, marital status, home and work addresses, or the like. Profile data may also include preference data, such as a particular coffee shop, fast food franchises, and so forth preferred by the user. Dislikes may also be provided. In embodiments, the at least one content item includes one of visible information, audible information, or a combination of visible and audible information.

The data mining component 126 is configured for mining data associated with the user and/or the computing device for use in selecting appropriate content items for output. For instance, the data mining component 126 may be configured to mine at least a portion of profile data associated with a user, data associated with a current state of the computing device 110, data indicative of a user's interactions with the computing device, user-activity data, data cached in association with the computing device and/or the content items selection engine 112, data stored in association with the data store 114, and/or any combination thereof. Data may be mined from the user's activities and other data sources occasionally, e.g., periodically and/or after some threshold amount of activity is reached, such as every fifty telephone calls. Examples of data mined from such activities include telephone numbers frequently called, calling patterns (e.g., analyzed through collaborative filtering and graph analysis), email addresses to which messages are regularly sent, other searches and advertisements, other application logs, location tracks, SMS content, and so forth. Examples of other information include things like social networking buddy lists, past purchases made via this device or an associated device, and the like. In embodiments, various profile data may be merged into a suitable data structure and, if desired, persisted in association with the user or device, such as by the device's telephone number. In this manner, profile data is regularly available to assist in decision making with respect to selecting content items to present, as more fully described below.

In embodiments, as part of the content item selection logic 124, keywords are extracted from data that is mined (e.g., utilizing data mining component 126) or otherwise received (e.g., by receiving component 122) and such extracted keywords are utilized as input into a search engine to aid in determining appropriate content items to provide for output. For instance, if a user receives an SMS that reads “let's meet at restaurant X at 7:00 pm,” the keyword “restaurant X” may be extracted and utilized as input into a search engine to cause retrieval of a map to and menu for restaurant X (or a link thereto). Subsequently, upon receiving an indication that the user desires a context-aware search to be conducted, the map and menu may be automatically presented—without the user inputting any keywords into the search engine themselves. Such content item retrieval may take place because the user is viewing the SMS message at the time the context-aware search is requested and/or because a context-aware search is requested in close time proximity to the 7:00 pm dinner appointment. Generally, in accordance with embodiments hereof, the content item(s) are retrieved and cached prior to the context-aware search being requested (e.g., utilizing cache 132). In embodiments, the content item selection logic 124 utilizes likelihoods/probabilities (e.g., assigned in accordance with the statistical inference engine 128) to reconcile which of multiple content items to provide for presentation. Each of these embodiments is more fully described below.

The statistical inference engine 128 is configured for determining which of a plurality of contextual indicators are more likely to generate desired content items and/or which of a plurality of content items are most likely to be desirable to the user to have presented at a particular point in time. For instance, if a user's electronic calendar indicates s/he is to meet a friend for dinner at 7:00 pm at a particular restaurant, is receipt of a contextual indicator of the friend's identity, the current location of the user, and/or the identity of the restaurant more likely to generate content items the user desires to view at a particular point in time than a contextual indicator that the user routinely checks traffic conditions at 6:00 pm before leaving his or her office? Or, is a content item linking to the friend's social networking page, a content item indicative of the restaurant menu, a content item linking to directions from the user's current location to the restaurant, and/or a content item linking to traffic conditions between the user's current location and the restaurant more likely to be desirable to the user to view?

In embodiments, the statistical inference engine 128 is configured to receive input of a plurality of relevant contextual indicators and utilize one or more statistical methodologies to assign a probability (or likelihood) to each. In other embodiments, the statistical inference engine 128 is configured to receive input of a plurality of content items and utilize one or more statistical methodologies to assign a probability (or likelihood) to each. Those contextual indicators and/or content items having the highest probability or likelihood that the user desires to view them, when taken into context of the remaining contextual indicators and/or content items, are utilized to provide the appropriate output to the user, as more fully described below. Embodiments hereof are not limited to uses of any particular statistical methodology and, accordingly, particular methodologies are not further described herein.

The output component 130 is configured for causing presentation of content items selected based upon one or more contextual indicators in association with the computing device of the user. For instance, the output component 130 is configured for causing presentation of one or more selected content items in association with the display screen 120 of the mobile computing device 110 of FIG. 1. While content items are described as being provided and presented, it is straightforward for the system 100 to provide a link or other reference by which the user may retrieve the relevant content item. Note that the link need not be followed by a conventional browser; for example, an application that outputs contacts or a call history list can follow the link, obtain the content item(s), and insert a representation of the content item(s) into its output. Any and all such variations, and any combination thereof, are contemplated to be within the scope of embodiments of the present invention.

Embodiments of the present invention provide rapid, efficient output of content items determined to be desirable to the user to view at a particular point in time upon receiving an indication that the user desires a context-aware search to be conducted. In order to provide the most rapid and efficient service possible, contextual indicators are continually received and content items are continually determined by the content item selection engine 112, that is, even before a context-aware search has been requested. Thus, in embodiments, at any given point in time, if an indication that the user desires to have a context-aware search conducted is received, the computing system environment 100 has already determined the content items for presentation at that point in time and can rapidly provide them to the user (e.g., in association with display screen 120 of the computing device 110). Thus, a cache 132 is utilized to have content items and/or links (references) thereto, continually at the ready. Among other benefits, caching avoids latency, which may be particularly advantageous when there is limited time to present information. Another benefit of having cached data is that the information can be displayed even in offline scenarios and scenarios where the network bandwidth costs are high (e.g., national and international roaming). The information contained in the cache 132 may change based upon receipt of new or additional contextual indicators and/or content items and some cached content items may not ever be output for presentation. The cache is thus utilized to ensure efficiency and rapid response upon receiving an indication that a user desires a context-aware search to be conducted. The cache 132 may be associated directly with the content items selection engine 112 as shown, or may be associated with the data store 114, if desired.

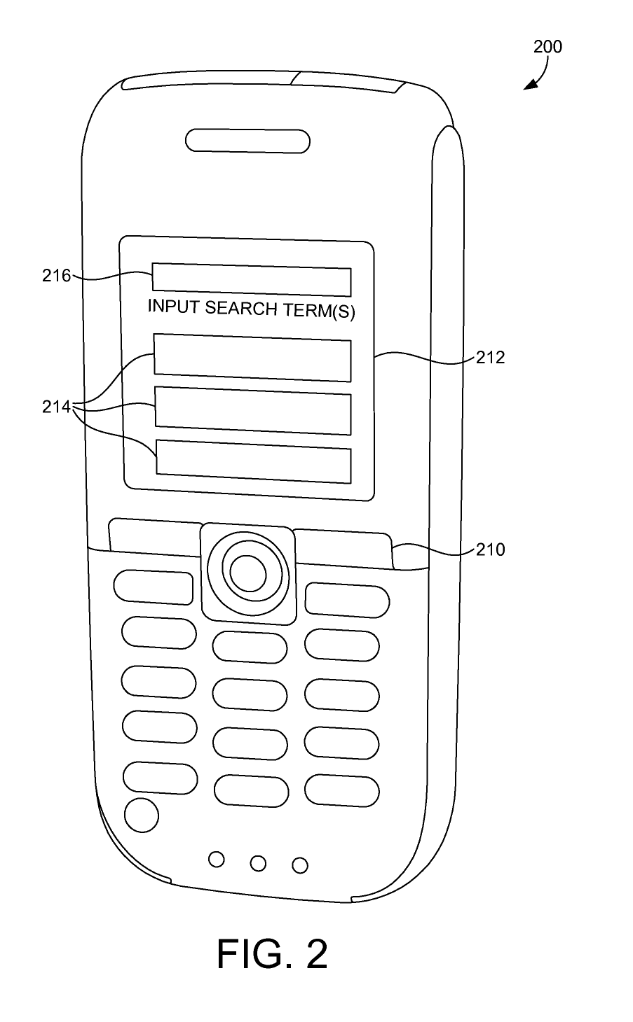

Turning now to FIG. 2, an exemplary mobile computing device 200 is shown that is suitable for use in implementing embodiments of the present invention. As shown in FIG. 2, the exemplary mobile computing device 200 includes a context-aware search selector 210, and a user interface 212 on which content items 214 selected based on context may be presented. In the illustrated embodiment, the context-aware search selector 210 is a hardware-based search selector. It will be understood by those of ordinary skill in the art that the context-aware search selector 210 may alternatively be a software-based search selector and/or a combination of a hardware-based and software-based search selector in accordance with embodiments hereof. In accordance with the present invention, content items 214 are presented in association with the user interface 212 only upon receiving an indication that the context-aware search selector 210 has been selected.

Upon receiving an indication that the context-aware search selector 210 has been selected, one or more content items 214 selected based upon context is presented in association with the user interface 112 of the computing device 200. Such content items 214 are presented automatically and without receiving any user-input search query terms. That is, based upon contextual indicators, an attempt is made to anticipate what the user desires to have presented upon selection of the context-aware search selector 210. Also presented is a search query input region 216 configured for receiving user-input search query terms. As such, if the present information (and/or information links) does not align with what the user wanted to have presented upon selecting the context-aware search selector 210, he or she may input search query terms and a search will be conducted for information related to the input terms in a conventional manner, though with an enhanced assessment of the intent of the user which may prove beneficial in determining search results.

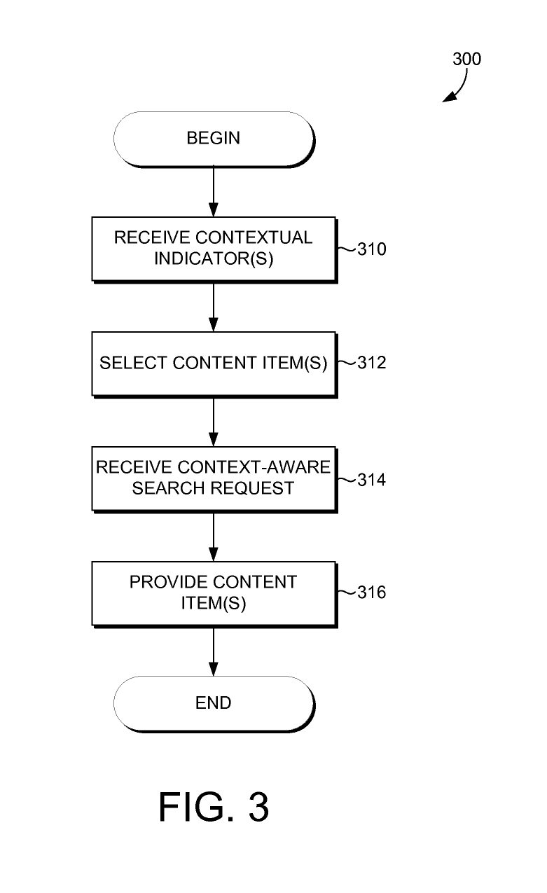

With reference to FIG. 3, a flow diagram is illustrated showing a method 300 for providing content items selected based on context, in accordance with an embodiment of the present invention. As shown at block 310, at least one contextual indicator associated with a user is received, for instance, by receiving component 122 of the content item selection engine 112 of FIG. 1. Using the at least one received contextual indicator, at least one content item is selected, as indicated at block 312 (e.g., utilizing one or more of content item selection logic 124, data mining component 126 and statistical inference engine 128 of the content item selection engine 112 of FIG. 1). The at least one content item may be one of visible information, audible information, or a combination of visible and audible information. As shown at block 314, an indication that a context-aware search has been requested is received, for instance, by receiving component 122 of the content item selection engine 112 of FIG. 1. Such indication may be received, for instance, upon a user selecting the selectable context-aware search selector 210 of FIG. 2. The at least one content item selected in response to the context-aware search request is automatically provided for output in association with the computing device, as indicated at block 316 (e.g., utilizing output component 130 of the content item selection engine 112 of FIG. 1). That is, the at least one content item selected in response to the context-aware search request is provided for output in association with the computing device without receiving any user-input search query terms.

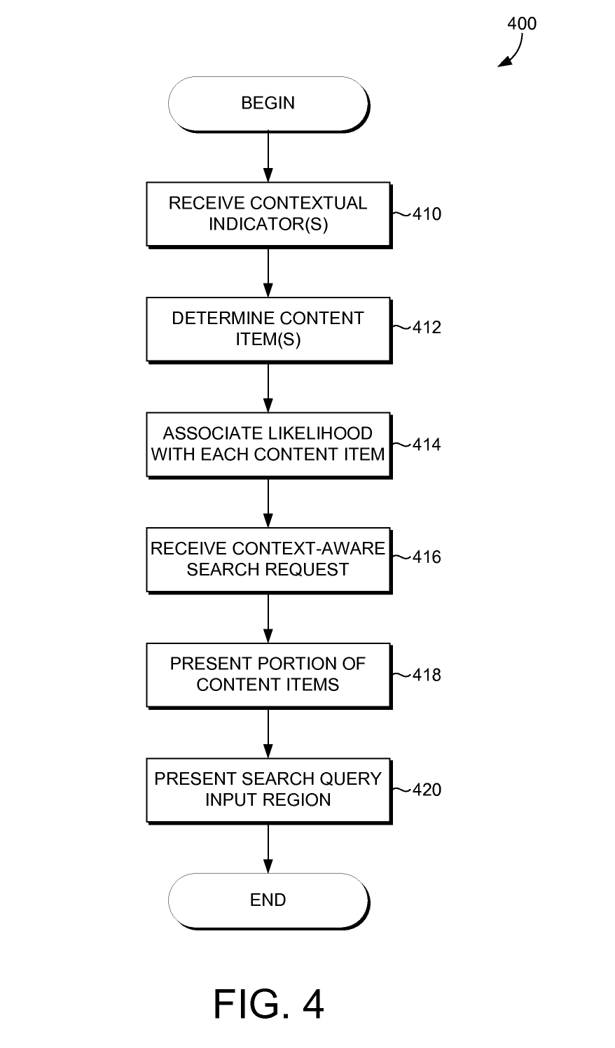

With reference to FIG. 4, a flow diagram is illustrated showing another method 400 for providing content items selected based on context, in accordance with an embodiment of the present invention. As indicated at block 410, a plurality of contextual indicators associated with a user is received, e.g., utilizing receiving component 122 of the content item selection engine 112 of FIG. 1. A plurality of content items capable of being presented in association with a user interface on the computing device is determined, as indicated at block 412 (e.g., utilizing one or more of content item selection logic 124, data mining component 126, or statistical inference engine 128 of the content item selection engine 112 of FIG. 1). Each of the plurality of content items is determined based upon at least one of the plurality of received contextual indicators. A likelihood is associated with each of the plurality of content items, e.g., utilizing statistical inference engine 128 of the content item selection engine 112 of FIG. 1, as indicated at block 414. The likelihood is indicative of how likely it is that the user wishes presentation of the associated content at that particular point in time, i.e., the point in time at which the likelihood is calculated.

As indicated at block 416, an indication that a context-aware search selector is received, e.g., by receiving component 122 of the content item selection engine 112 of FIG. 1. Such indication may be received, for instance, upon a user selecting the selectable context-aware search selector 210 of FIG. 2. At least a portion of the plurality of content items selected in response to the context-aware search request is automatically provided for output in association with a first region of the user interface of the computing device, as indicated at block 418 (e.g., utilizing output component 130 of the content item selection engine 112 of FIG. 1). That is, at least a portion of the plurality of content items selected in response to the context-aware search request is provided for output in association with the user interface (e.g., user interface 212 of FIG. 2) of the computing device (e.g., computing device 200 of FIG. 2) without receiving any user-input search query terms. The content items comprising the portion of the plurality of content items are selected for presentation based upon relative associated likelihoods, for instance, utilizing statistical inference engine 128 of FIG. 1. Those content items having the highest probability or likelihood that the user desires to view them, when taken into context of the remaining content items, are utilized to provide the appropriate output to the user. Also presented, as indicated at block 420, is a search query input region configured for receiving at least one user-input search query term in association with a second region of the user interface (e.g., user interface 212 of FIG. 2) of the computing device (e.g., computing device 200 of FIG. 2). Thus, if the presented information (and/or information links) does not align with what the user wanted to have presented upon selecting the context-aware search button, he or she may input search query terms and a search will be conducted for information related to the input terms in a conventional manner, though with an enhanced assessment of the intent of the user which may prove beneficial in determining search results.

As can be seen, embodiments of the present invention provide rapid, efficient output of content items (or references/links thereto) determined to be desirable to the user to view at a particular point in time upon receiving an indication that the user desires a context-aware search to be conducted. Thus, by the simple selection of a single button, the user may be presented with information that is highly relevant at the time of selection. Exemplary uses may include: A user wakes up in the morning and selects a context-aware search selector and is automatically presented with the weather, stock information, news, etc. In this instance, the system has learned based on previous activities of the user with respect to the computing device. In another example, a user receives an SMS indicating a friend desires to meet at restaurant X at 7:00 pm and, while viewing the message, selects a context-aware search selector. The user is then automatically presented with a map to the restaurant and menu. This eliminates the cut-and-paste activity the user would otherwise have engaged in to receive the same information. In yet another example, a user desires to call John Doe. She browses her contact list until she arrives at John Doe's listing, at which point the context-aware search selector is selected. In this instance, John Doe's social networking page is presented for review before making the call. In another example, a user is currently attending a ball game at a particular arena and presses the context-aware search selector. The system utilizes the state information (location and time) of the device to automatically provide output of a game roster and player statistics. In another example, a user visits a large retail store and finds an item he may wish to purchase. He utilizes the computing device camera (e.g., cell phone camera) to take a picture of the barcode and then selects the context-aware search selector and is automatically shown a price comparison page for the item. Still further, a user checks into a hotel in city X and selects the context-aware search selector at 6:00 pm. As the system is aware this is the time the user generally eats dinner, a listing of nearby restaurants for the user's favorite cuisine, as well as a map and a mobile coupon are presented. These and other examples are contemplated to be within the scope of embodiments of the present invention.

### Exemplary Operating Environments

A first exemplary operating environment in which various aspects of the present invention may be implemented is described below in order to provide a general context for various aspects of the present invention. Referring to FIG. 5 in particular, an exemplary operating environment for implementing embodiments of the present invention is shown and designated generally as computing device 500. The computing device 500 is but one example of a suitable computing environment and is not intended to suggest any limitation as to the scope of use or functionality of the invention. Neither should the computing device 500 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 5, the computing device 500 includes a bus 510 that directly or indirectly couples the following devices: memory 512, one or more processors 514, one or more presentation components 516, input/output ports 518, input/output components 520, and an illustrative power supply 522. The bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 5 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 5 and reference to “computing device.”

The computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 512 includes computer-storage media in the form of volatile and/or nonvolatile memory. The memory may be removable, non-removable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

The I/O ports 518 allow computing device 500 to be logically coupled to other devices including the I/O components 520, some of which may be built in. Illustrative components include a microphone, joystick, game pad, satellite dish, scanner, printer, wireless device, etc.

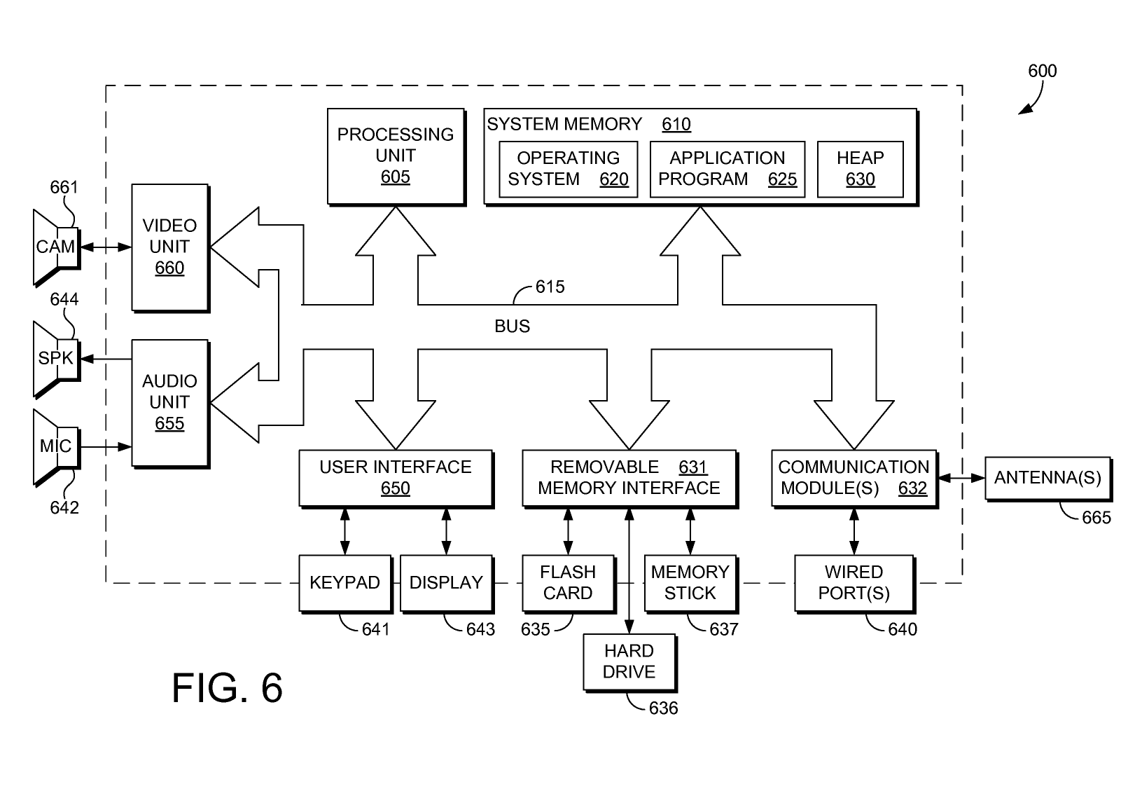

With reference to FIG. 6, an exemplary device for implementing aspects of the subject matter described herein includes a mobile device 600. Though embodiments of the present invention are not limited to implementation on mobile devices, FIG. 6 illustrates an example of a suitable mobile device 600 on which aspects of the subject matter described herein may be implemented. The mobile device 600 is only one example of a device and is not intended to suggest any limitation as to the scope of use or functionality of aspects of the subject matter described herein. Neither should the mobile device 600 be interpreted as having any dependency or requirement relating to any one or combination of components illustrated in the exemplary mobile device 600.

In some embodiments, the mobile device 600 comprises a cell phone, a handheld device that allows voice communications with others, some other voice communications device, or the like. In these embodiments, the mobile device 600 may be equipped with a camera for taking pictures, although this may not be required in other embodiments. In other embodiments, the mobile device 600 comprises a personal digital assistant (PDA), hand-held gaming device, notebook computer, printer, appliance including a set-top, media center, or other appliance, other mobile devices, or the like. In yet other embodiments, the mobile device 600 may comprise devices that are generally considered non-mobile such as personal computers, servers, or the like.

Components of the mobile device 600 may include, but are not limited to, a processing unit 605, system memory 610, and a bus 615 that couples various system components including the system memory 610 to the processing unit 605. The bus 615 may include any of several types of bus structures including a memory bus, memory controller, a peripheral bus, and a local bus using any of a variety of bus architectures, and the like. The bus 615 allows data to be transmitted between various components of the mobile device 600.

The mobile device 600 may include a variety of computer-readable media. Computer-readable media can be any available media that can be accessed by the mobile device 1300 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 600.

Communication media may include any information delivery media, typically embodied in computer-readable instructions, data structures, program modules, and/or may include or other data in a modulated data signal such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, Wi-Fi, WiMAX, and other wireless media. Combinations of any of the above also may be included within the scope of computer-readable media.

The system memory 610 includes computer storage media in the form of volatile and/or nonvolatile memory and may include read only memory (ROM) and random access memory (RAM). On a mobile device such as a cell phone, operating system code 620 is sometimes included in ROM although, in other embodiments, this is not required. Similarly, application programs 625 are often placed in RAM although again, in other embodiments, application programs may be placed in ROM or in other computer-readable memory. The heap 630 provides memory for state associated with the operating system 620 and/or the application programs 625. For example, the operating system 620 and application programs 625 may store variables and data structures in the heap 630 during their operations.

The mobile device 600 may also include other removable/non-removable, volatile/nonvolatile memory. By way of example, FIG. 6 illustrates a flash card 635, a hard disk drive 636, and a memory stick 637. The hard disk drive 636 may be miniaturized to fit in a memory slot, for example. The mobile device 600 may interface with these types of non-volatile removable memory via a removable memory interface 631, or may be connected via a universal serial bus (USB), IEEE 694, one or more of the wired port(s) 640, or antenna(s) 665. One of the antennas 665 may receive GPS data. In these embodiments, the removable memory devices 635-637 may interface with the mobile device via the communications module(s) 632. In some embodiments, not all of these types of memory may be included on a single mobile device. In other embodiments, one or more of these and other types of removable memory may be included on a single mobile device.

In some embodiments, the hard disk drive 636 may be connected in such a way as to be more permanently attached to the mobile device 600. For example, the hard disk drive 636 may be connected to an interface such as parallel advanced technology attachment (PATA), serial advanced technology attachment (SATA) or otherwise, which may be connected to the bus 615. In such embodiments, removing the hard drive may involve removing a cover of the mobile device 600 and removing screws or other fasteners that connect the hard drive 636 to support structures within the mobile device 600.

The removable memory devices 635-637 and their associated computer storage media, described above and illustrated in FIG. 6, provide storage of computer-readable instructions, program modules, data structures, and other data for the mobile device 600. For example, the removable memory device or devices 635-637 may store images taken by the mobile device 600, voice recordings, contact information, programs, data for the programs and so forth.

A user may enter commands and information into the mobile device 600 through input devices such as a keypad 641 and the microphone 642. In some embodiments, the display 643 may be touch-sensitive screen and may allow a user to enter commands and information thereon. The keypad 641 and display 643 may be connected to the processing unit 605 through a user input interface 650 that is coupled to the bus 615, but may also be connected by other interface and bus structures, such as the communications module(s) 632 and wired port(s) 640.

A user may communicate with other users via speaking into the microphone 642 and via text messages that are entered on the key pad 641 or a touch sensitive display 643, for example. The audio unit 655 may provide electrical signals to drive the speaker 644 as well as receive and digitize audio signals received from the microphone 642.

The mobile device 600 may include a video unit 660 that provides signals to drive a camera 661. The video unit 660 may also receive images obtained by the camera 661 and provide these images to the processing unit 605 and/or memory included on the mobile device 600. The images obtained by the camera 661 may comprise video, one or more images that do not form a video, or some combination thereof.

The communication module(s) 632 may provide signals to and receive signals from one or more antenna(s) 665. One of the antenna(s) 665 may transmit and receive messages for a cell phone network. Another antenna may transmit and receive Bluetooth® messages. Yet another antenna (or a shared antenna) may transmit and receive network messages via a wireless Ethernet network standard.

In some embodiments, a single antenna may be used to transmit and/or receive messages for more than one type of network. For example, a single antenna may transmit and receive voice and packet messages.

When operated in a networked environment, the mobile device 600 may connect to one or more remote devices. The remote devices may include a personal computer, a server, a router, a network PC, a cell phone, a peer device or other common network node, and typically includes many or all of the elements described above relative to the mobile device 600.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the method 300 of FIG. 3 and the method 400 of FIG. 4 are not meant to limit the scope of the present invention in any way and, in fact, the steps may occur in a variety of different sequences within embodiments hereof. For instance, contextual indicators may be received subsequent to receiving a request for a context-aware search, within the scope of embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer storage media having computer-executable instructions embodied thereon, that when executed, cause a computing device to perform a method for providing content items selected based on context, the method comprising:
receiving at least one contextual indicator associated with a user;
using the at least one contextual indicator to select at least one content item, the at least one content item being one of visible information, audible information, or a combination of visible and audible information;
receiving an indication that a context-aware search has been requested;
automatically providing the at least one content item for output in association with the computing device in response to the context-aware search request and in the absence of receiving any user-input search query terms.

2. The one or more computer storage media of claim 1, wherein the at least one content item comprises, at least in part, visible information, and wherein the method further comprises:
displaying the visible information in association with a user interface in response to the context-aware search request; and
displaying a search query input region configured for receiving at least one user-input search query term in association with the user interface.

3. The one or more computer storage media of claim 1, wherein receiving the indication that the context-aware search has been requested comprises receiving an indication that a context-aware search selector has been selected.

4. The one or more computer storage media of claim 3, wherein the context-aware search selector is one of a hardware-based search selector associated with the computing device, a software-based search selector, and a combination of a hardware-based and a software-based search selector.

5. The one or more computer storage media of claim 1, wherein automatically providing the at least one content item for output in association with the computing device in response to the context-aware search request comprises accessing a remote source of the at least one content item, accessing a local cache synchronized from a remote source of the at least one content item, or a combination thereof.

6. The one or more computer storage media of claim 1, wherein the computing device is a mobile computing device.

7. The one or more computer storage media of claim 1,
wherein using the at least one contextual indicator to select the at least one content item comprises using the at least one contextual indicator to select the at least one contextual indicator prior to receiving the indication that the context-aware search has been requested,
and wherein the method further comprises caching the at least one content item.

8. The one or more computer storage media of claim 1,
wherein receiving the at least one contextual indicator associated with the user comprises receiving a plurality of contextual indicators associated with the user,
and wherein using the at least one contextual indicator to select the at least one content item comprises selecting a plurality of content items, each of the plurality of content items being selected based on one or more of the plurality of contextual indicators.

9. The one or more computer storage media of claim 8, wherein automatically providing the at least one content item for output in association with the computing device in response to the context-aware search request comprises automatically providing at least a portion of the plurality of content items for output in association with the computing device in response to the context-aware search request.

10. The one or more computer storage media of claim 9, wherein the method further comprises associating a likelihood with each of the plurality of content items indicative of how likely it is that the user wishes presentation of the associated content item, and wherein automatically providing at least a portion of the plurality of content items for output in association with the computing device comprises automatically providing less than all of the plurality of content items based upon the likelihood associated with each of the plurality of content items.

11. The one or more computer storage media of claim 1, further comprising using profile data, current state data, or a combination of profile data and current state data to select the at least one content item.

12. The one or more computer storage media of claim 11, further comprising mining at least a portion of the profile data based on previous activities of the user.

13. The one or more computer storage media of claim 1, wherein the at least one contextual indicator associated with the user is based on at least one interaction of the user with the computing device.

14. A content delivery system, comprising:
a computing device associated with one or more processors and one or more computer storage media;
a data store coupled with the computing device; and
a content item selection engine that receives at least one contextual indicator associated with a user of the computing device, selects at least one content item based upon the at least one contextual indicator, and automatically provides the at least one content item for output in association with the computing device in response to receiving an indication that a context-aware search has been requested and in the absence of receiving any user-input search query terms.

15. The content delivery system of claim 14, further comprising a context-aware search selector, selection of which generates the indication that the context-aware search has been requested.

16. The content delivery system of claim 14, wherein the content item selection engine uses profile data, current state data, or a combination of profile data and current state data to select the at least one content item.

17. The content delivery system of claim 16, wherein the content item selection engine mines at least a portion of the profile data based on previous activities of the user to select the at least one content item.

18. The content delivery system of claim 14, wherein the at least one contextual indicator associated with the user of the computing device is based on at least one interaction of the user with the computing device.

19. One or more computer storage media having computer-executable instructions embodied thereon, that when executed, cause a computing device to perform a method for providing content items selected based on context, the method comprising:
receiving a plurality of contextual indicators associated with a user;
determining a plurality of content items capable of being presented in association with a user interface on the computing device, each of the plurality of content items being determined based upon at least one of the plurality of contextual indicators;
associating a likelihood with each of the plurality of content items indicative of how likely it is that the user wishes presentation of the associated content item;
receiving an indication that a context-aware search selector has been selected;
automatically presenting a portion of the plurality of content items in association with a first region of the user interface in response to the selection of the context-aware search selector and in the absence of receiving any user-input search query terms, wherein content items comprising the portion of the plurality of content items are selected for presentation based upon relative associated likelihoods; and presenting a search query input region configured for receiving at least one user-input search query term in association with a second region of the user interface in response to the selection of the context-aware search selector.

20. The one or more computer storage media of claim 19, wherein each of the plurality of contextual indicators associated with the user is determined using one or more of profile data, current state data, user-activity data, user/device interaction data, and any combination thereof.
